(19) United States
(12) Patent Application Publication
(10) Pub. No.: US 2018/0253820 A1
(43) Pub. Date: Sep. 6, 2018

(54) SYSTEMS, METHODS, AND DEVICES FOR GENERATING VIRTUAL REALITY CONTENT FROM TWO-DIMENSIONAL IMAGES

(71) Applicant: Immersive Enterprises, LLC, New York, NY (US)

(72) Inventors: Brian A. Knott, Stanford, CA (US); Taher Baderkhan, New York, NY (US)

(21) Appl. No.: 15/900,641

(22) Filed: Feb. 20, 2018

Related U.S. Application Data
(60) Provisional application No. 62/466,574, filed on Mar. 3, 2017.

(51) Int. Cl. G06T 3/00; G06T 3/60

(52) U.S. Cl. CPC G06T 3/0062; G06T 3/60

(57) ABSTRACT

Computer systems, methods, and devices for generating virtual reality content from two-dimensional images. In some embodiments, a computer-implemented method for generating virtual reality content from a two-dimensional image can comprise applying horizon correction to a two-dimensional input image for conversion, converting the image to a part-spherical and part-cylindrical projection, applying a vertical correction to the part-spherical and part-cylindrical projection, converting the vertically corrected projection to an equirectangular image, applying a mirroring process to the equirectangular image, and transmitting the same to a virtual reality device for display as virtual reality content.

### CROSS-REFERENCE TO RELATED APPLICATIONS

The present application claims the benefit under 35 U.S.C. § 119(c) of U.S. Provisional Application No. 62/466,574, filed Mar. 3, 2017, and entitled “Systems, Methods, and Devices for 3D Depiction of 2D Projections,” which is hereby incorporated herein by reference in its entirety under 37 C.F.R. §1.57.

### BACKGROUND

### Technical Field

The present application relates to computer systems, methods, and devices for generating virtual reality content from two-dimensional images.

### Description

Development of virtual reality technology has rapidly increased over the last few years. Virtual reality technology can provide a user with fully immersive experiences, for example by providing fully three-dimensional and 360-degree video or other virtual reality content. However, virtual reality content can be limited in availability and/or may require extensive editing compared to traditionally available content such as two-dimensional planar images or video.

All patents and other documents referred to in this application are incorporated by reference herein in their entirety.

### SUMMARY

Over the past few years, there has been a major increase in the development of virtual reality technology. With the development of virtual reality technology, three-dimensional content can be viewed in 360 degrees, for example, to provide users with an immersive and/or fully immersive experience. However, creation of virtual reality content to such effect can require an extensive amount of data processing and may require specialized equipment and/or software. Accordingly, the amount or quantity of virtual reality content can be rather limited especially compared to more traditional forms of content, such as two-dimensional images. As such, it can be advantageous to provide ways to easily create virtual reality content from widely available two-dimensional planar images. Accordingly, some embodiments herein are directed to methods, systems, and devices for generating virtual reality content from two-dimensional images.

In some embodiments, a computer-implemented method for processing a two-dimensional flat image to generate virtual reality content comprises: receiving, by a computer system, selection of a two-dimensional image for conversion to virtual reality content; identifying, using the computer system, a top quadrant, an upper middle quadrant, a lower middle quadrant, and a bottom quadrant of the two-dimensional image, wherein the upper middle quadrant and the lower middle quadrant comprise one or more features to protect from distortion; converting, by the computer system, the two-dimensional image to a part-spherical and part-cylindrical projection by: applying a spherical projection to the top quadrant and the bottom quadrant; and applying a cylindrical projection to the upper middle quadrant and the lower middle quadrant; applying, by the computer system, a vertical correction of the part-spherical and part-cylindrical projection of the two-dimensional image by reproducing the part-spherical and part-cylindrical projection into a spherical projection; converting, by the computer system, the spherically converted projection of the part-spherical and part-cylindrical projection of the two-dimensional image to a first equirectangular image, wherein the first equirectangular image comprises a first viewing angle of substantially 180 degrees; mirroring, by the computer system, one or more portions of the first equirectangular image to obtain a second equirectangular image, wherein the second equirectangular image comprises a width substantially twice as wide as a width of the first equirectangular image, and wherein the second equirectangular image comprises a second viewing angle of substantially 360 degrees; and storing the second equirectangular image on a server for displaying on a virtual reality viewing device as virtual reality content, wherein the computer system comprises a computer processor and an electronic storage medium.

In certain embodiments, the computer-implemented method further comprises determining, by the computer system, a likelihood of success of converting the two-dimensional image to virtual reality content. In certain embodiments, determining the likelihood of success of converting the two-dimensional image to virtual reality content is based at least in part on one or more of a view direction of the two-dimensional image, presence of homogeneous textures in the top quadrant of the two-dimensional image, presence of homogenous textures in the bottom quadrant of the two-dimensional image, field of view of the two-dimensional image, or presence of orthogonal structures in the top quadrant of the two-dimensional image.

In certain embodiments, the computer-implemented method further comprises, identifying, by the computer system, one or more portions of the two-dimensional image with a likelihood of success of conversion to virtual reality content above a predetermined threshold. In certain embodiments, the determining the top quadrant, the upper middle quadrant, the lower middle quadrant, and the bottom quadrant of the two-dimensional image is performed automatically by the computer system. In certain embodiments, the determining the top quadrant, the upper middle quadrant, the lower middle quadrant, and the bottom quadrant of the two-dimensional image is performed by a user utilizing a computerized tool on the computer system.

In certain embodiments, a boundary of the upper middle quadrant and the lower middle quadrant corresponds to a horizon line of the two-dimensional image. In certain embodiments, the computer-implemented method further comprises adjusting vertical heights of the top quadrant and the bottom quadrant to position the horizon line at a center of the two-dimensional image. In certain embodiments, applying the spherical projection to the top quadrant and the bottom quadrant comprises stretching at least a portion of the top quadrant and the bottom quadrant. In certain embodiments, reproduction of the part-spherical and part-cylindrical projection into the spherical projection decreases inner-quadrant vertical distortion. In certain embodiments, the mirroring comprises identifying one or more vertical lines of low energy and flipping a portion of the first equirectangular projection across the one or more vertical lines. In certain embodiments, the computer-implemented method further comprises generating and transmitting a URL directed to an electronic storage location on the server of the second equirectangular image to the virtual reality device, wherein activation of the URL by the virtual reality device initiates display of the second equirectangular image as virtual reality content.

In some embodiments, a system for processing a two-dimensional flat image to generate virtual reality content comprises: one or more computer readable storage devices configured to store a plurality of computer executable instructions; and one or more hardware computer processors in communication with the one or more computer readable storage devices and configured to execute the plurality of computer executable instructions in order to cause the system to: receive selection of a two-dimensional image for conversion to virtual reality content; receive identification of a top quadrant, an upper middle quadrant, a lower middle quadrant, and a bottom quadrant of the two-dimensional image, wherein the upper middle quadrant and the lower middle quadrant comprise one or more features to protect from distortion; convert the two-dimensional image to a part-spherical and part-cylindrical projection by: applying a spherical projection to the top quadrant and the bottom quadrant; and applying a cylindrical projection to the upper middle quadrant and the lower middle quadrant; apply a vertical correction of the part-spherical and part-cylindrical projection of the two-dimensional image by reproducing the part-spherical and part-cylindrical projection into a spherical projection; convert the spherically converted projection of the part-spherical and part-cylindrical projection of the two-dimensional image to a first equirectangular image, wherein the first equirectangular image comprises a first viewing angle of substantially 180 degrees; mirror one or more portions of the first equirectangular image to obtain a second equirectangular image, wherein the second equirectangular image comprises a width substantially twice as wide as a width of the first equirectangular image, and wherein the second equirectangular image comprises a second viewing angle of substantially 360 degrees; and store the second equirectangular image on a server for displaying on a virtual reality viewing device as virtual reality content.

In certain embodiments, the system is further caused to generate and transmit a URL directed to an electronic storage location of the second equirectangular image on the server to the virtual reality device, wherein activation of the URL by the virtual reality device initiates display of the second equirectangular image as virtual reality content. In certain embodiments, the system is further caused to determine a likelihood of success of converting the two-dimensional image to virtual reality content. In certain embodiments, determining the likelihood of success of converting the two-dimensional image to virtual reality content is based at least in part on one or more of a view direction of the two-dimensional image, presence of homogeneous textures in the top quadrant of the two-dimensional image, presence of homogenous textures in the bottom quadrant of the two-dimensional image, field of view of the two-dimensional image, or presence of orthogonal structures in the top quadrant of the two-dimensional image.

In certain embodiments, the system is further caused to adjust vertical heights of the top quadrant and the bottom quadrant to position a boundary between the upper middle quadrant and the lower middle quadrant at a center of the two-dimensional image. In certain embodiments, applying the spherical projection to the top quadrant and the bottom quadrant comprises stretching at least a portion of the top quadrant and the bottom quadrant. In certain embodiments, reproduction of the part-spherical and part-cylindrical projection into the spherical projection decreases inner-quadrant vertical distortion. In certain embodiments, the mirroring comprises identifying one or more vertical lines of low energy and flipping a portion of the first equirectangular projection across the one or more vertical lines.

All of these embodiments are intended to be within the scope of the invention herein disclosed. These and other embodiments will become readily apparent to those skilled in the art from the following detailed description having reference to the attached figures, the invention not being limited to any particular disclosed embodiment(s).

### BRIEF DESCRIPTION OF THE DRAWINGS

A better understanding of the devices and methods described herein will be appreciated upon reference to the following description in conjunction with the accompanying drawings, wherein:

FIG. 1A depicts an example of virtual reality content generated from a two-dimensional image using an embodiment of the systems, methods, and devices herein;

FIG. 1B depicts an example of virtual reality content generated from a two-dimensional image using an embodiment of the systems, methods, and devices herein;

FIG. 2 is a flowchart depicting an overview of embodiments of methods for generating virtual reality content from a two-dimensional image;

FIG. 3 is a flowchart depicting embodiments of methods for conducting initial analysis of a two-dimensional image for generating virtual reality content;

FIG. 4A depicts an example of a spherical projection obtained from a two-dimensional input image with positive elevation without applying horizon correction;

FIG. 4B depicts an example of a spherical projection obtained from a two-dimensional input image with negative elevation without applying horizon correction;

FIG. 4C is a flowchart depicting embodiments of methods for applying horizon correction to a two-dimensional image for generating virtual reality content;

FIG. 4D depicts an example embodiment of defining four quadrants of a two-dimensional image for generating virtual reality content;

FIG. 5A is a flowchart depicting embodiments of methods for applying a spherinder projection to a two-dimensional image for generating virtual reality content;

FIG. 5B depicts an illustrative example of applying a spherinder projection to a two-dimensional image for generating virtual reality content;

FIG. 6A depicts an example planar projection of a spherinder projection obtained from a two-dimensional input image without applying pole protection and/or vertical correction;

FIG. 6B depicts the spherinder projection of FIG. 6A of the two-dimensional image when viewed as virtual reality content;

FIG. 6C is a flowchart depicting embodiments of methods for applying pole protection and/or vertical correction to a spherinder projection obtained from a two-dimensional input image for generating virtual reality content;

FIG. 6D depicts an illustrative example of applying vertical correction and/or pole protection to a spherinder projection obtained from a two-dimensional input image for generating virtual reality content;

FIG. 6E depicts an example planar projection of a spherinder projection obtained from a two-dimensional input image without applying pole protection and/or vertical correction;

FIG. 6F depicts the planar projection of FIG. 6E of the spherinder projection obtained from the two-dimensional input image after applying pole protection and/or vertical correction;

FIG. 7A is a flowchart depicting embodiments of methods for applying mirroring to a vertically corrected projection, such as a spherinder projection, of a two-dimensional image for generating virtual reality content;

FIG. 7B depicts an example planar projection of a vertically corrected projection, such as a spherinder projection, of a two-dimensional image after applying an embodiment of mirroring;

FIG. 7C depicts an example planar projection of a vertically corrected projection, such as a spherinder projection, of a two-dimensional image after applying an embodiment of smart mirroring;

FIG. 8 is an embodiment of a schematic diagram illustrating embodiments of a virtual reality content generation system; and

FIG. 9 is a block diagram depicting embodiments of a computer hardware system configured to run software for implementing one or more embodiments of a virtual reality content generation system.

The patent or application file contains at least one drawing executed in color. Copies of this patent or patent application publication with color drawing(s) will be provided by the Office upon request and payment of the necessary fee.

### DETAILED DESCRIPTION

Although several embodiments, examples, and illustrations are disclosed below, it will be understood by those of ordinary skill in the art that the inventions described herein extend beyond the specifically disclosed embodiments, examples, and illustrations and includes other uses of the inventions and obvious modifications and equivalents thereof. Embodiments of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Various embodiments described herein relate to computer systems, methods, and devices for generating virtual reality content from two-dimensional images. With the development of virtual reality technology, virtual reality devices and content can provide users with an immersive and/or fully immersive viewing experience through three-dimensional content viewable in 360 degrees. However, in order to provide such effects, creation of virtual reality content can require a substantial amount of data processing and time. Specialized data processing software and/or equipment may also be required for generating virtual reality content. As such, the number of available virtual reality content is rather limited relative to two-dimensional content or other non-virtual reality content, as such concerns are generally not applicable as two-dimensional content is easy to capture and edit. Further, an abundant amount of two-dimensional content can be easily found on the Internet. Accordingly, it can be advantageous to be able to generate or create virtual reality content from other non-virtual reality content, such as two-dimensional planar images, that are more widely available, for example on the Internet. Further, an additional advantage is that one may be able to generate virtual reality content using personal two-dimensional planar images, video, or other content to provide an immersive viewing experience of one's choice. Certain embodiments herein address these concerns and/or needs by providing methods, systems, and devices for generating virtual reality content from two-dimensional images. Some embodiments herein can thereby increase the amount of available virtual reality content and/or allow virtual reality content creation easy for both professional and non-professional users.

In particular, in some embodiments, the system is configured to receive a selection of a two-dimensional image from a user for converting to virtual reality content. For example, the two-dimensional image can be uploaded from a user device and/or selected from a pre-existing database. The system can, in certain embodiments, conduct an initial analysis of the selected two-dimensional image to determine whether the image has a high likelihood of successfully being converted to virtual reality content. For example, images in which the view direction is parallel to the ground level may have a higher likelihood of success of conversion. In addition, images with homogeneous textures at the top and/or bottom of the image may be more likely to be successfully converted to virtual reality content. Moreover, images with a wide field of view and/or images without orthogonal structures near the edges may also have a higher likelihood of conversion success than others. Further, images without features near the top and/or bottom may be more likely to be successfully converted to virtual reality content.

In certain embodiments, prior to conversion and/or as part of the conversion process, the system can be configured identify one or more portions, such as four quadrants, of the selected image. The four quadrants may be identified along a vertical direction and/or a horizontal direction of the image. For example, the system may identify a top quadrant, an upper middle quadrant, a lower middle quadrant, and a bottom quadrant of the image. As such, in some embodiments, the system may identify one or more portions of the image divided vertically along one or more horizontal boundaries. In other embodiments, the system may identify one or more portions of the image divided horizontally along one or more vertical boundaries. Any features of interest that should be protected from distortion can be located either in the upper middle quadrant and/or the lower middle quadrant. The boundaries of the four quadrants can be adjusted in some embodiments, for example by a user, to ensure that all or substantially all features of interest appear in the upper middle and/or lower middle quadrants. In some embodiments, the top quadrant and the lower quadrant can be distorted through the conversion process, while distortion of the upper middle and lower middle quadrants can be minimized or substantially prevented.

The system can further be configured to initially convert the two-dimensional flat image into a spherinder projection or a part-spherical and part-cylindrical projection. For example, a spherical or half-spherical projection can be applied to the top and bottom quadrants, while a cylindrical projection can be applied to the upper middle and lower middle quadrants. In other words, the upper middle and lower middle quadrants can be converted to a cylindrical form or projection, while the top quadrant is converted to a top half of a sphere or dome and the bottom quadrant is converted to a bottom half of a sphere or dome, resulting in a pill-shaped projection. More specifically, the boundary between the top quadrant and the upper middle quadrant can correspond to an equator line of a sphere, wherein the uppermost portion of the top quadrant can be wrapped into a point, thereby forming a spherical cap with a flat bottom. Similarly, the boundary between the bottom quadrant and the lower middle quadrant can correspond to an equator line of a sphere, wherein the lowermost portion of the bottom quadrant can be wrapped into a point, thereby forming a spherical cap with a flat top.

In some embodiments, vertical distortion can occur if the spherinder projection is then directly flattened to an equirectangular format. In other words, certain features in the image can appear taller than intended. As such, in certain embodiments, the system can be configured to apply a vertical correction to the spherinder projection to account for such vertical distortion. The vertical correction can involve reproducing the spherinder projection onto a spherical projection. In order to do so, certain portions of the top and/or bottom quadrants can be removed in some embodiments. As such, it can be important to ensure that all features of interest appear in the upper middle and/or lower middle quadrants.

By converting or reproducing the spherinder projection to a sphere, vertical distortion can be accounted for when flattened to an equirectangular form for viewing on a virtual reality device. However, in some embodiments, because the initial starting image was a two-dimensional flat image with a viewing angle of substantially 180 degrees or less, the resulting flattened equirectangular image of the spherically converted spherinder projection may only correspond to a vertically cut half sphere. That is, the viewing angle of the resulting flattened equirectangular image may comprise a viewing angle of only 180 degrees. As a result, in some embodiments, when the flattened equirectangular image is wrapped around a sphere for virtual reality viewing purposes, a user may only be able to view half of a sphere without being able to view anything behind the user.

As such, in order to provide a full spherical view in virtual reality, in some embodiments, the system can be configured to mirror the flattened equirectangular image to obtain a final equirectangular image corresponding to a full sphere. In other words, the system can be configured to apply one or more mirroring techniques or processes to obtain a final equirectangular image that is substantially twice as wide as the initial equirectangular image, but with the same height. In some embodiments, the system can be configured to apply a simple mirror, in which the initial equirectangular image is simply doubled or mirrored along a vertical axis. In other embodiments, the system can be configured to mirror one or more portions of the initial equirectangular image along one or more vertical axes. For example, certain portions of the initial equirectangular image may be mirrored at least once, while other portions may not be mirrored at all.

In some embodiments, the system can electronically store the final equirectangular image for displaying on a virtual reality viewing device. For example, the system may electronically transmit the final equirectangular image to a virtual reality device. In certain embodiments, the system may electronically store the final equirectangular image on a server and allow one or more virtual reality devices to access the stored final equirectangular image for viewing or displaying. For example, in some embodiments, the system may generate and/or transmit a URL to a virtual reality viewing device, in which the URL can point to a location on the server where the final equirectangular image is stored. The final equirectangular image can be streamed in real-time or substantially real-time or near real-time in some embodiments to a virtual reality device for displaying.

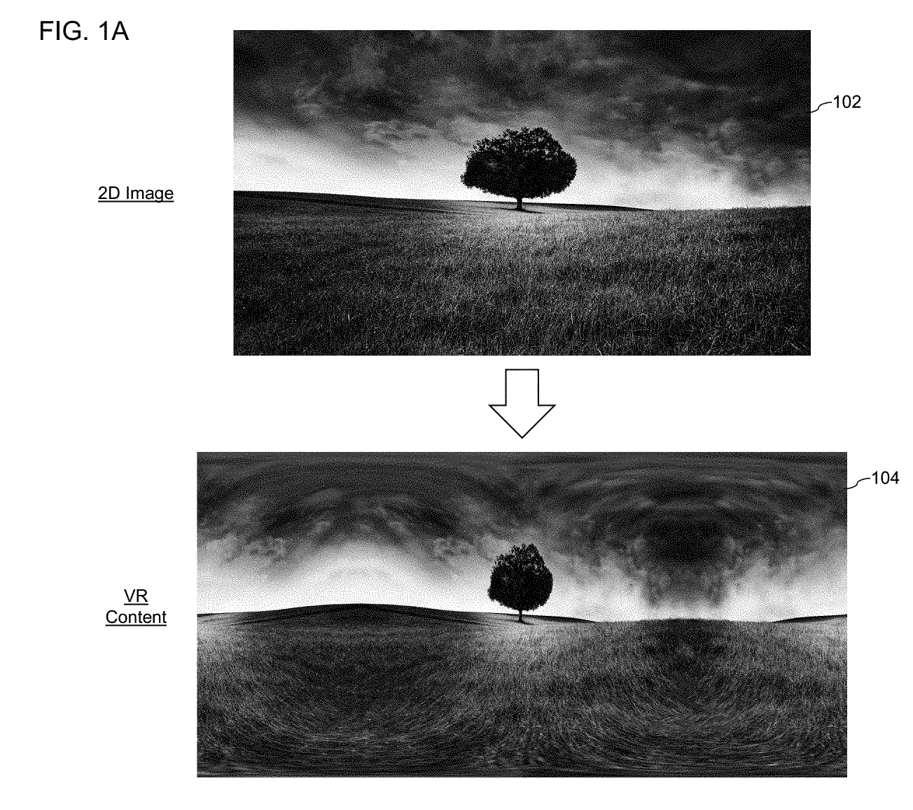

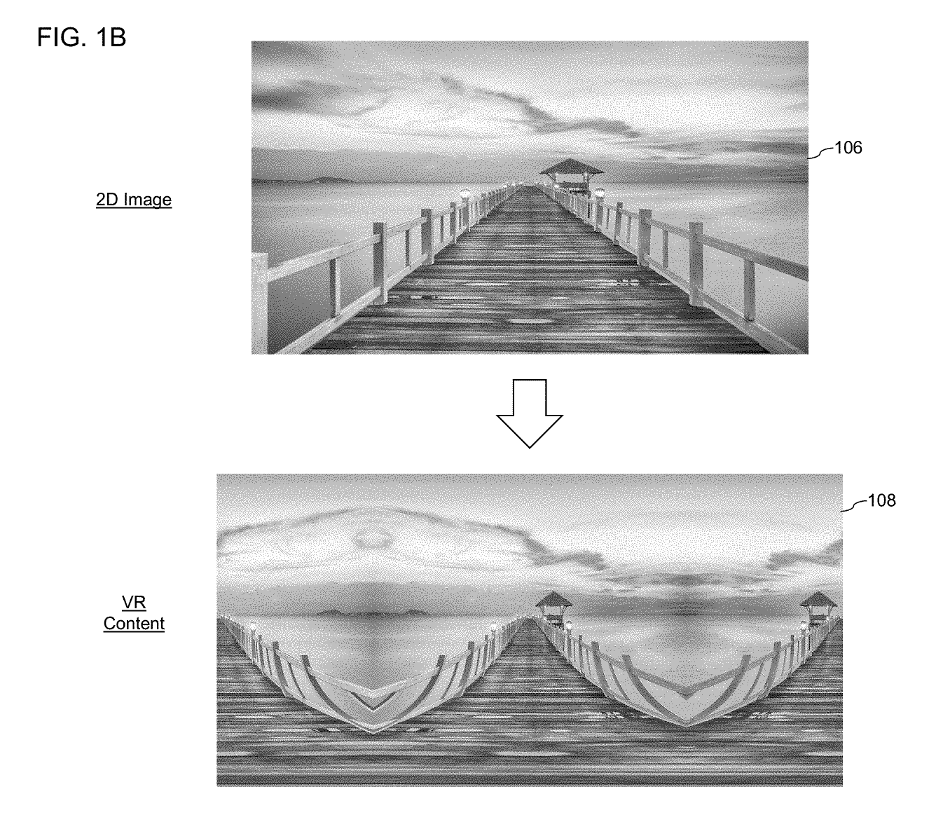

FIG. 1A illustrates an example of virtual reality content that was generated from a two-dimensional planar image using one or more embodiments of the systems, methods, and devices described herein. As illustrated in FIG. 1A, a two-dimensional planar image 102 can be converted and/or used as a basis for generating virtual reality content 104 or equirectangular form while preserving features or key features. As depicted, virtual reality content 104 can be projected to an equirectangular output. In some embodiments, when an equirectangular projection of virtual reality content 104 is projected onto and/or wrapped around a sphere, for example when viewing through a virtual reality viewing device, a user can see a full-sphere view in 360 degrees of the two-dimensional planar image 102 that was used as the basis for creating the virtual reality content 104 without losing features or key features. As such, in some embodiments, users can select a two-dimensional planar image and/or other non-virtual reality content for generating virtual reality content of the user's selection to output an equirectangular image for creating an immersive or fully immersive virtual reality viewing experience in 360 degrees and/or in a full sphere without losing key features.

FIG. 1B illustrates another example of virtual reality content that was generated from a two-dimensional image using one or more embodiments of the systems, methods, and devices described herein. As illustrated in FIG. 1B, a bridge going into the horizon as shown in a two-dimensional image 106. This two-dimensional image 106 can then be transformed and/or converted into virtual reality content 108 using one or more embodiments of the systems, methods, and devices herein. As illustrated in FIG. 1B, the virtual reality content 108 can be projected to an equirectangular output. When this equirectangular projection of the converted virtual reality content 108 is wrapped around a sphere, for example when viewed on a virtual reality viewing device, a user can see a view of the bridge going into the horizon. At the same time, the two-halves of the bridge shown in the left and right edges of the equirectangular projection of virtual reality content 108 can be merged to form another view of the bridge extending in the opposite direction behind the user. As such, a user can experience standing in the middle of a bridge that extends both forwards and backwards from the location of the user. In other words, some embodiments discussed herein allow a user to stretch or otherwise modify a planar image to show the image in a spherical form as opposed to a flat plane while preserving features or key features. Accordingly, by converting two-dimensional images into virtual reality content, users may experience a more immersive and/or fully immersive view.

### Overview

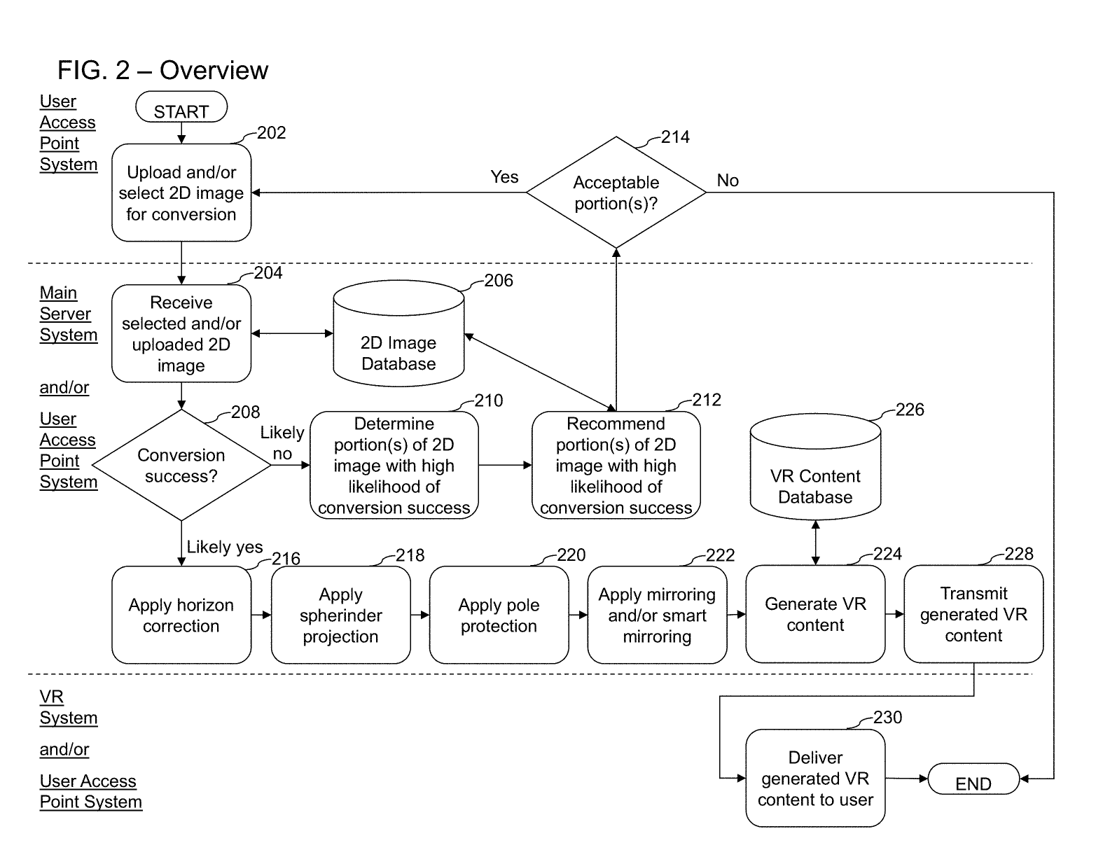

FIG. 2 illustrates a flowchart depicting an overview of certain embodiments of methods for generating virtual reality content or equirectangular output from a two-dimensional image or planar image input. Each and every imaging processing technique or feature described herein can be automated and/or semi-automated, for example by using a computerized tool. As illustrated in FIG. 2, in certain embodiments, a user may upload and/or select a two-dimensional image or planar image input for conversion at block 202, for example from a user access point system. The user access point system can be a smartphone, laptop, personal computer, or other computer device. The two-dimensional image can be selected from available content, such as from the Internet, or can be from user input, such as a photograph taken by the user. Further, the two-dimensional image or planar image input for conversion can be selected from one or more preexisting databases, for example a personal photo album stored on an electronic storage device, and/or can be merely uploaded through a user access point system. For example, in certain embodiments, a user can take a photograph or picture and upload using the user access point system at block 202 for conversion to virtual reality content.

In some embodiments, a main server system and/or user access point system can receive the user-selected and/or uploaded two-dimensional image or planar image input at block 204. The received two-dimensional image that was selected and/or uploaded by a user can be stored in an electronic storage database in some embodiments. For example, in some embodiments, the main server system and/or user access point system can further be configured to electronically store the two-dimensional image that was selected and/or uploaded by a user in a two-dimensional image database 206 for future reference. As such, the system may allow a user to retrieve a previously selected two-dimensional image from the two-dimensional image database 206.

In certain embodiments, the main server system and/or user access point system can be further configured to determine whether the selected and/or uploaded two-dimensional or planar image input image has a high or low likelihood of success of being converted into virtual reality data or an equirectangular output at block 208. For example, in some embodiments, the main server system and/or user access point system can be configured to determine a value corresponding to the likelihood of conversion success of the two-dimensional image into virtual reality content at block 208. Additional detail regarding specific processes techniques relating to a determination of the likelihood of conversion success of the two-dimensional image into virtual reality data or content are further discussed in detail below.

In certain embodiments, if the main server system and/or user access point system determines that the likelihood of conversion success of the two-dimensional image into virtual reality content is low and/or below a predetermined threshold level, the system can be configured to determine one or more portions of the two-dimensional image that comprise a high or at least higher likelihood of conversion success into virtual reality content at block 210. For example, the predetermined threshold value of likelihood of success can be about 99%, about 98%, about 97%, about 96%, about 95%, about 90%, about 85%, about 80%, about 75%, about 70%, about 65%, about 60%, about 55%, about 50%, and/or within a range defined by two of the aforementioned values.

Further, in some embodiments, based on the determination, the main server system and/or user access point system can be configured to recommend one or more portions of the two-dimensional image with a high or higher likelihood of conversion success into virtual reality content at block 212. The recommended and/or determined one or more portions of the two-dimensional image with a higher likelihood of conversion success can also be stored in electronic storage medium, such as the two-dimensional image database 206, for example for future reference and/or machine learning to develop one or more automated or semi-automated processes.

In some embodiments, the recommended and/or determined one or more portions of the two-dimensional image with a high likelihood of conversion success to virtual reality content can be delivered from the main server system and/or user access point system to the user access point system at block 214. Based on the displayed one or more portions of the two-dimensional image, the user can determine whether the one or more portions are acceptable at block 214. If acceptable, the user can select on the user access point system one or more portions of the two-dimensional image for conversion in a similar manner as described above in relation to block 202. However, if the user determines that there are no acceptable portions for conversion to virtual reality content in block 214 the process can end.

Referring back to block 208, if the system determines that the likelihood of success of converting the two-dimensional image into virtual reality content is high and/or is above a predetermined threshold value, the system can be configured to further apply one or more processes or techniques for converting the two-dimensional image into virtual reality content. For example, in some embodiments, the system can be configured to apply a horizon correction technique or process at block 216. In certain embodiments, the system can be configured to apply one or more projections, such as a spherinder projection at block 218. In some embodiments, the system can be configured to apply a pole protection technique or process at block 220. In addition, in certain embodiments, the system can be configured to apply one or more mirroring techniques or processes at block 222, such as smart mirroring. Additional detail regarding processes and techniques relating to horizon correction, spherinder projection, pole protection, and/or mirroring are discussed below.

In some embodiments, based on one or more image processing techniques, the system can be configured to generate virtual reality content at block 224. The generated virtual reality content from the user-selected and/or uploaded two-dimensional image can be stored in an electronic storage medium, such as a virtual reality content database 226, for example for future reference and/or machine learning purposes. In some embodiments, the generated virtual reality content can subsequently be transmitted electronically from the main server system and/or user access point system to a virtual reality system, device, and/or user access point system at block 228, for example after compression. For example, in some embodiments, the main server system and/or user access point system electronically transmits an equirectangular output to the virtual reality system, device, and/or user access point system. In certain embodiments, the main server system and/or user access point system electronically stores the equirectangular output and generates a URL directed to the electronic storage location. This URL can then be transmitted to the virtual reality system, devices, and/or user access point system for accessing, retrieving, and/or displaying the equirectangular output as virtual reality content. The virtual reality system, device, and/or user access point system can deliver the generated virtual reality content to a user at block 230, for example by projecting an equirectangular output of virtual reality content to a sphere, thereby allowing a user to experience an immersive and/or fully immersive virtual reality experience using virtual reality content that the user generated from two-dimensional or other non-virtual reality content.

In some embodiments, one or more processes or techniques described herein can be implemented with Three.js and JQuery with a WebGL fragment shader. Specifications can be made by a user on the fly using user interface (UI) tools and/or controls. An advantage of such embodiments is that the processing speed can be very fast because Three.js and WebGL support graphics processing unit (GPU) rendering. In certain embodiments, one or more processes or techniques described herein can be implemented in C using OpenCV and/or pixel-level image processing to provide fastest CPU processing. In certain embodiments, one or more processes or techniques described herein can be implemented in Python using Open CV; however, such embodiments may be slower than others. In some embodiments, one or more processes or techniques described herein can be implemented in Matlab, with a user interface (UI) created using GUIDE for example. Smart mirroring processes and techniques as described herein can be implemented in embodiments that use Matlab for example. In some embodiments, one or more processes or techniques described herein can be provided to users in form of software and/or API to allow users to upload, select, and/or process a planar input image for conversion to virtual reality content.

### Pre-Analysis

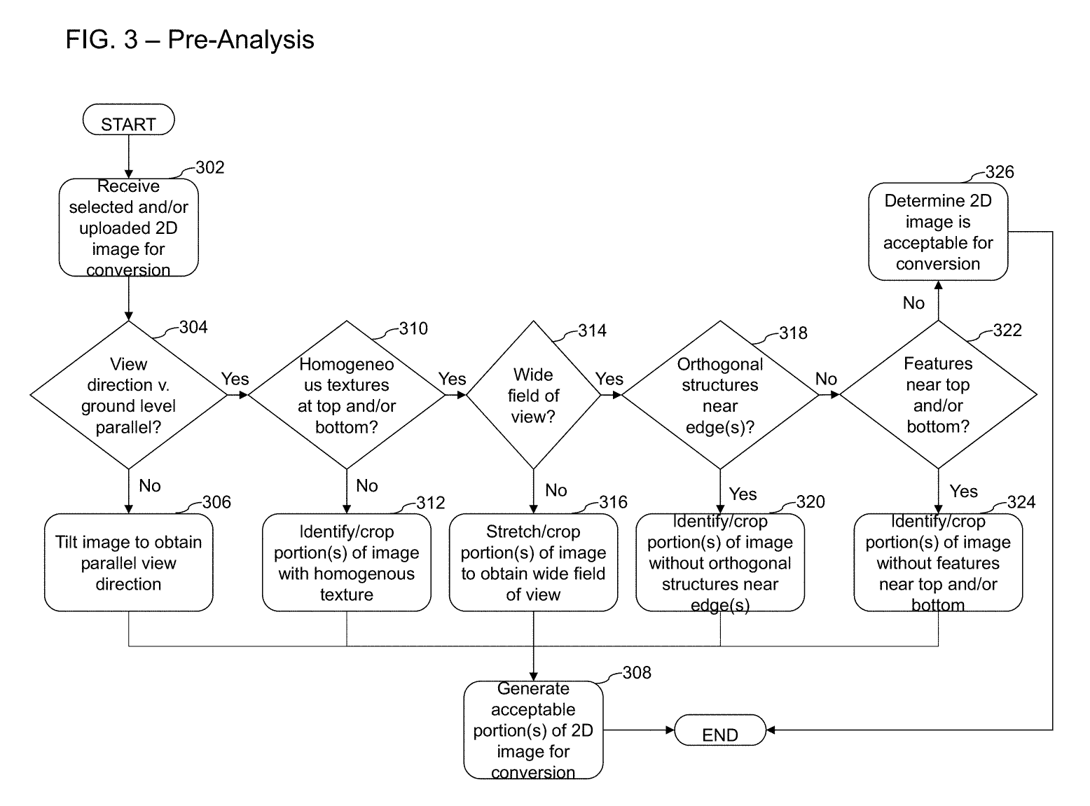

FIG. 3 is a flowchart depicting one or more embodiments of methods for conducting pre-analysis or initial processing of a two-dimensional image for generating virtual reality content. For example, one or more processes or techniques described and/or illustrated in connection with FIG. 3 can relate to a determination by the system regarding a likelihood of conversion success of a two-dimensional image into virtual reality content. In certain embodiments, certain images or certain types of images can have a higher likelihood of success of conversion to virtual reality data or content compared to others. In other words, certain images or types of images can be more likely to be converted to equirectangular format without distortion or less distortion and preserve key features. As such, it can be advantageous for the system to be able to determine a likelihood of success of conversion and to convey that determination to a user such that the user can select or identify an appropriate two-dimensional image or one or more portions thereof for converting to virtual reality content.

In some embodiments, the system can be configured to receive a user-selected and/or uploaded two-dimensional image or planar image input at block 302 for conversion to virtual reality content or an equirectangular output. The system can then be configured to determine the likelihood of success of converting the selected and/or uploaded two-dimensional image into virtual reality content by employing one or more techniques or processes described herein.

In some embodiments, for example, the system can be configured to determine, through an automated, semi-automated, or manual process, whether a view direction of the input image is parallel to the ground level at block 304. An input image with a view direction that is parallel or generally parallel to the ground level can have a higher likelihood of success for conversion to virtual reality content or an equirectangular output in certain embodiments. In some embodiments, if the system determines that the view direction is not substantially parallel of the image, the system can be further configured to tilt the input image and/or one or more portions of the input image to obtain a view direction that is generally parallel to the ground level at block 306. Conversely, if the view direction of the image is generally or substantially parallel to the ground level, the system can determine that the likelihood of success of converting the image to virtual reality content is high and/or proceed to apply one or more other techniques or processes for determination of the same.

In certain embodiments, the system can be configured to automatically determine a view direction of an image and/or a ground level. Based on such determination, the system can be configured to compare the angle of the view direction relative to the ground level. In some embodiments, if the angle between the view direction of the image and the ground level therein is below a predetermined threshold value, the system can be configured to determine that the likelihood of conversion success of the input image to an equirectangular output is high. Conversely, if the angle between the view direction of the image and the ground level therein is above a predetermined threshold level, the system can be configured to determine that the likelihood of conversion success of the input image to an equirectangular output is low. This predetermined threshold value can be, for example, about 0 degrees, about 1 degree, about 2 degrees, about 3 degrees, about 4 degrees, about 5 degrees, about 10 degrees, about 15 degrees, about 20 degrees, about 25 degrees, about 30 degrees, and/or within a range determined by two of the aforementioned values.

In certain embodiments, the system can be configured to determine, through an automated, semi-automated, or manual process, whether the image comprises homogenous textures at the top and/or bottom of the image at block 310. For example, homogenous textures can include grass, dirt, sky, or the like. In some embodiments, the top and/or bottom portions of an input image can be susceptible to distortion. As such, having homogenous textures at the top and/or bottom of an input image can increase the likelihood of success of conversion of the image to virtual reality content or equirectangular output without or with less distortion. In contrast, having non-homogenous features at the top and/or bottom of the photograph or image may result in apparent distortion when converting a two-dimensional input image into an equirectangular output for virtual reality content.

In order to determine whether an input planar image comprises homogenous textures at the top and/or bottom of the image, the system can be configured to analyze and/or process one or more pixels of the image. For example, the system can be configured to determine and/or analyze a color and/or shade of a particular pixel at or near the top and/or bottom of the image. The system can then further be configured to conduct a similar analysis of the color and/or shade of a pixel adjacent to the first pixel, and continue to do so for a plurality of pixels at the top and/or bottom of the image, for example along a horizontal, vertical, or diagonal line. Based on such determination, the system can be configured to determine a gradient of change and color and/or shade at the top and/or bottom of the image. If this gradient of change and color or shade of the pixels at the top and/or bottom of the image is above a predetermined threshold, the system can be configured to determine that the top and/or bottom of the image comprises non-homogenous textures, and thereby determine that the likelihood of conversion success is low. Conversely, if the system determines that the gradient of change in color and/or shade among a plurality of pixels at the top and/or bottom of the image is below a predetermined threshold, the system can determine that the top and/or bottom of the image comprises homogenous textures.

The top and/or bottom portions of the image, as discussed in relation to block 310, can be defined as about 5% from the top and/or bottom edge of the image in some embodiments. In certain embodiments, the top and/or bottom of the image, when measured from the top and/or bottom edge of the image can be about 10%, about 15%, about 20%, about 25%, about 30%, and/or within a range defined by two of the aforementioned values. Further, as discussed in relation to block 310, the predetermined threshold value for the gradient change in color and/or shade to determine the presence of homogenous or non-homogenous textures can be, for example, about 1%, about 2%, about 3%, about 4%, about 5%, about 10%, about 15%, about 20%, about 25%, about 30%, and/or within a range defined by two of the aforementioned values.

If the system determines that the two-dimensional image does not comprise homogenous textures at the top and/or bottom of the two-dimensional image at block 310, the system can be configured to identify and/or crop one or more portions of the image that comprises homogenous textures at the top and/or bottom at block 312. In contrast, if the system determines that the two-dimensional image comprises homogenous textures at the top and/or bottom, the system can be configured to determine that the likelihood of success of converting the image to virtual reality content is high and/or proceed to apply one or more other techniques or processes for determination of the same.

In certain embodiments, the system can be configured to determine, through an automated, semi-automated, or manual process, whether the image has a wide field of view at block 314. In some embodiments, if the selected input image comprises a wide field of view, it can be possible to maximize the effective total output image angle represented after mirroring, thereby decreasing risk of distortion. As such, if the image comprises a wide field of view, the likelihood of success of conversion of a planar input image to virtual reality data can be relatively high.

For example, if the field of view as determined by the system of the image is at or above 180 degrees, the system can be configured to determine that the likelihood of success of conversion to virtual reality content is high. In certain embodiments, the system can determine that the likelihood of success of conversion to virtual reality content is high if the field of view of the image is at or above about 360 degrees, about 350 degrees, about 340 degrees, about 330 degrees, about 320 degrees, about 310 degrees, about 300 degrees, about 250 degrees, about 200 degrees, about 150 degrees, about 100 degrees, and/or within a range defined by two of the aforementioned values.

If the system determines that the field of view of the image is not wide or below a predetermined threshold value, the system in certain embodiments can be configured to stretch and/or crop one or more portions of the input image to obtain a new image for conversion with a wide field of view in block 316. Conversely, if the system determines that the image comprises a wide field of view, the system can be configured to determine that the likelihood of success of converting the image to virtual reality content is high and/or proceed to apply one or more other techniques or processes for determination of the same.

In certain embodiments, the system can be configured to determine, through an automated, semi-automated, or manual process, whether the image comprises one or more orthogonal structures near one or more edges of the input image at block 318. In some embodiments, images without Manhattan lines or orthogonal structures toward the edges of the input planar image can have a higher likelihood of conversion success to virtual reality content. This can be because objects that extend beyond the image boundaries, such as hallways or the like, may not be successfully completed or converted by one or more processes or techniques. In certain embodiments, one exception can be that certain objects such as roads and bridges that extend directly forward in an image can be convincingly mirrored with appropriate input settings, for example by setting the bottom feature close to the horizon line among others.

If the system determines that the image comprises one or more orthogonal structures near its edges at block 318, the system can be configured to identify and/or crop one or more portions of the image without orthogonal structures near the edges of block 320 in order to increase the likelihood of conversion to virtual reality content. Conversely, if the system determines that there are no orthogonal structures near the edges of the image, the system can be configured to determine that the likelihood of success of converting the image to virtual reality content is high and/or proceed to apply one or more other techniques or processes for determination of the same.

In some embodiments, the system can be configured to determine, through an automated, semi-automated, or manual process, whether the image comprises one or more features near the top and/or bottom of the image at block 322. In certain embodiments, images with features extending very high and/or low in the image can have a lower likelihood of conversion success into virtual reality content. This can be because of potential pole distortion that may affect non-homogenous features at the top and/or bottom of the image.

If the system determines that the planar input image comprises features near the top and/or bottom of the image at block 322, the system in certain embodiments can be configured to identify and/or crop one or more portions of the image without features near the top and/or bottom in order to increase the likelihood of conversion success to virtual reality content at block 324. Conversely, if the system determines that there are no features near the top and/or bottom of the input image, the system can be configured to determine that the likelihood of success of converting the image to virtual reality content is high and/or proceed to apply one or more other techniques or processes for determination of the same.

In some embodiments, the system can be configured to conduct a pre-analysis or initial analysis of an image input selected for conversion that comprises each or a subset of the techniques or processes described above, including determining whether the view direction of the image is parallel to the ground level, determining whether the image comprises homogenous textures at the top and/or bottom of the image, determining whether the image comprises a wide field of view, determining whether the image comprises one or more orthogonal structures near the edges, and/or determining whether the image comprises one or more features near the top and/or bottom of the image.

In certain embodiments, if one or more of the previously mentioned processes result in a determination by the system that a likelihood of conversion success of the two-dimensional image to virtual reality content is high and/or is above a predetermined threshold level, the system can be configured to determine that the two-dimensional image is acceptable for conversion at block 326. Further, in some embodiments, if one or more of the previously mentioned processes result in a determination by the system that a likelihood of conversion success of the two-dimensional image to virtual reality content is low and/or is below a predetermined threshold level, the system can be configured to determine that the two-dimensional image is not acceptable for conversion at block 326.

In certain embodiments in which the system is configured to further crop, identify, stretch, and/or tilt one or more portions of the image to obtain a modified version of the two-dimensional image with a higher likelihood of conversion, the system can be configured to generate and/or transmit to a user access point system one or more acceptable portions of the two-dimensional image for conversion at block 308. For example, in some embodiments in which the system is configured to tilt the image to obtain a parallel view direction to the ground level, the system can be configured to generate an acceptable version of the two-dimensional image for conversion at block 308.

Similarly, in certain embodiments in which the system is configured to identify and/or crop one or more portions of the image comprising homogenous textures at the top and/or bottom of the cropped image, the system can be configured to generate an acceptable, modified version of the two-dimensional image for conversion at block 308. Also, in certain embodiments in which the system is configured to stretch and/or crop one or more portions of the image to obtain a wide field of view of the image, the system can be configured to generate an acceptable modified version of the two-dimensional image for conversion at block 308. In addition, in embodiments in which the system is configured to identify and/or crop one or more portions of the image not comprising orthogonal structures near the edges, the system can be configured to generate an acceptable modified version of the two-dimensional image for conversion at block 308. Lastly, in embodiments in which the system can be configured to identify and/or crop one or more portions of the image not comprising features near the top and/or bottom, the system can be configured to generate an acceptable modified version of the two-dimensional image for conversion at block 308.

### Horizon Correction

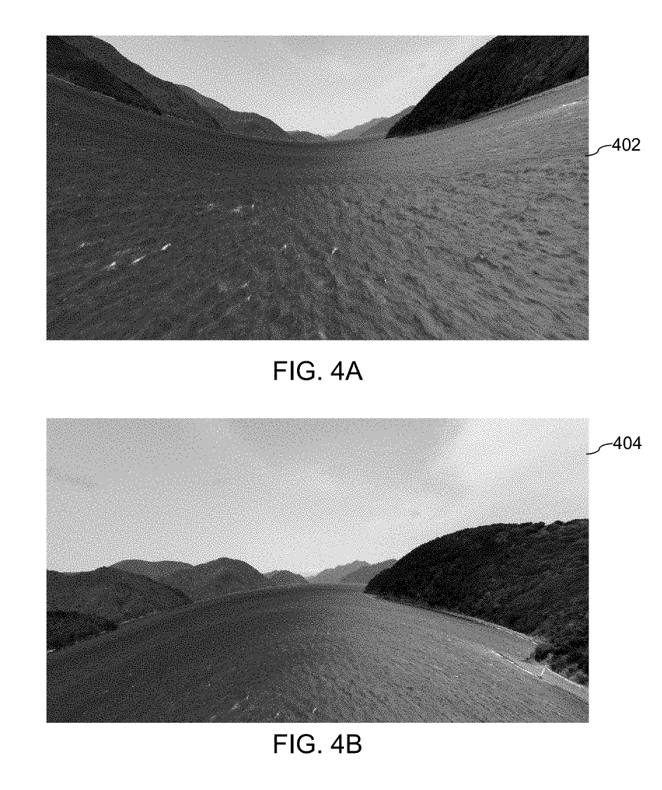

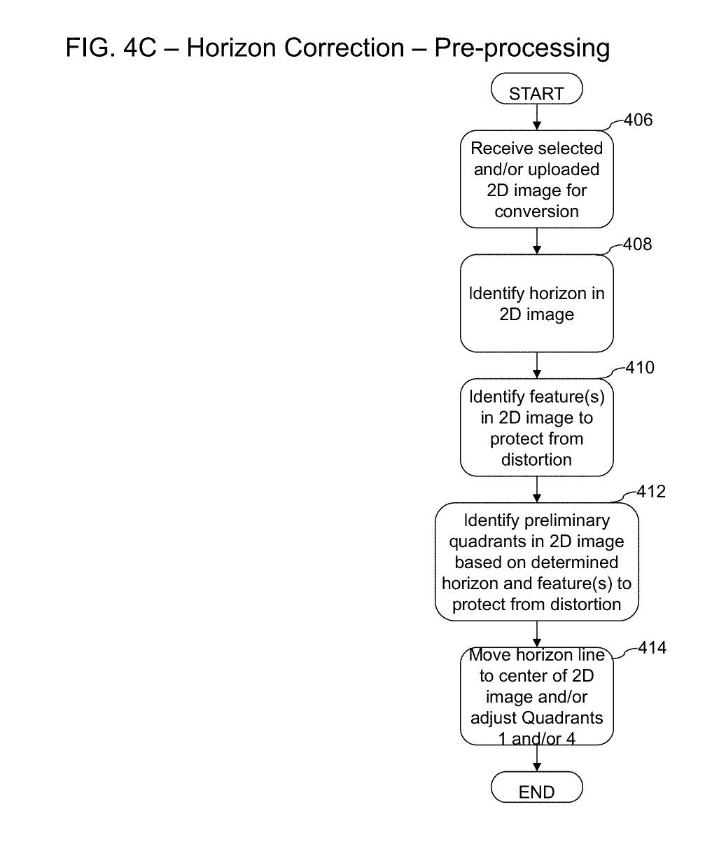

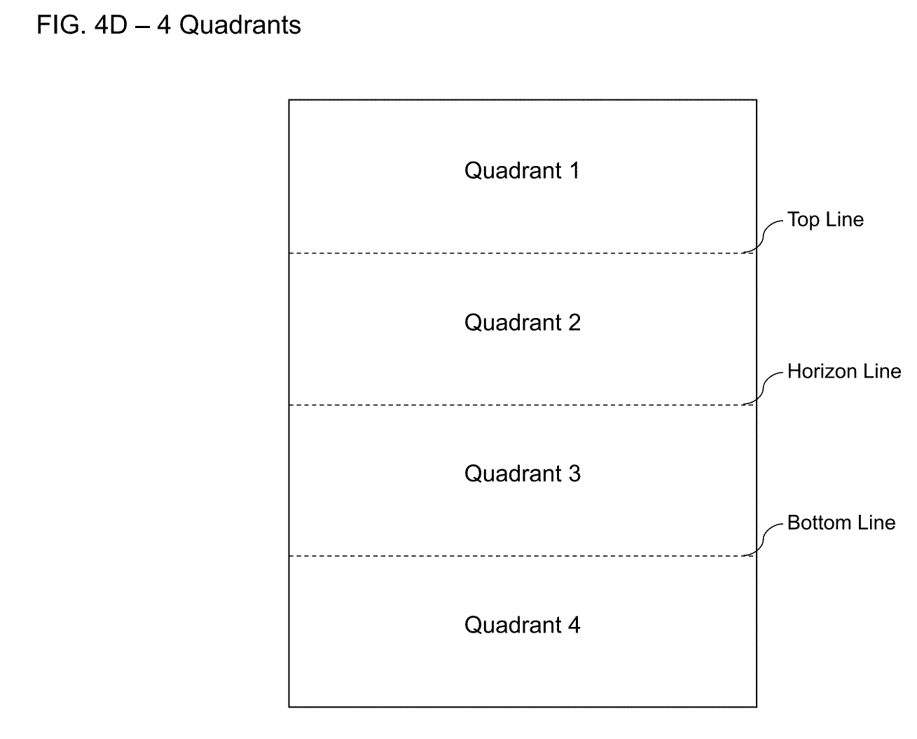

In some embodiments, the system can be configured to conduct horizon correction of a two-dimensional input image prior to and/or as part of the conversion to virtual reality content. This technique can comprise for example centering the horizon of the image. By applying this technique, the floor of the image can be modified to appear flat and when converted into a spherical projection by ensuring that the horizon has zero elevation, thereby preventing or at least decreasing distortion. In some embodiments, a horizon with positive elevation results in a spherical image where the ground appears to have a bowl shape. Conversely, a horizon with a negative elevation can result in a spherical image or projection where the ground appears to have a hill shape. For example, FIG. 4A illustrates an example of a spherical projection obtained from a two-dimensional input image with positive elevation without applying any horizon correction. FIG. 4B illustrates an example of a spherical projection obtained from a two-dimensional input image with negative elevation without applying any horizon correction. As illustrated in FIGS. 4A and 4B, a spherical projection obtained from a two-dimensional input image without applying any horizon correction can result in a distorted spherical image. As such, it can be advantageous to apply horizon correction to a two-dimensional input image for converting to virtual reality content.

FIG. 4C is a flowchart illustrating one or more embodiments of methods for applying horizon correction to a two-dimensional input image for generating virtual reality content. As illustrated in FIG. 4C, in some embodiments, a system can be configured to receive a selected and/or uploaded two-dimensional input image for conversion at block 406. Based on the received two-dimensional image, the system can be configured to first identify a horizon line in the two-dimensional image in block 408, through an automated, semi-automated, or manual process.

In order to identify the horizon line in the two-dimensional image, the system can be configured to utilize edge detection and/or analyze the color and/or shading of a plurality of pixels along a vertical line within the image for example. Based on the determined color and/or shade of a plurality of pixels along a vertical line, the system can be further configured to analyze a gradient or change in the color and/or shade of a plurality of pixels along a vertical line. For example, if the gradient change is large and/or above a predetermined threshold level between two adjacent pixels along a vertical line, the system can be configured to determine that the position in between those two pixels corresponds to the horizon line. In certain embodiments, the system can allow a user to identify and/or input the location of the horizon. For example, in some embodiments, the system can allow a user to draw, identify, and/or select a horizontal line corresponding to the location of the horizon in the two-dimensional image.

In certain embodiments, the system can be configured to identify one or more features in the two-dimensional image to protect from distortion at block 410. For example, one or more features to protect from distortion can correspond to the main subject of the photograph or input image. In some embodiments, the system can be configured to identify one or more features located near the center or middle of the image as feature(s) to protect from distortion. In other embodiments, the system can allow a user to identify one or more features in the two-dimensional image to protect from distortion. For example, the system can allow a user to click or otherwise select one or more features in the two-dimensional image to protect from distortion.

Based on the identified horizon and/or one or more features in the image to protect from distortion, the system can be configured to identify preliminary quadrants in the two-dimensional image at block 412. An example embodiment of defining four quadrants of a two-dimensional image for generation virtual reality content is illustrated in FIG. 4D. For example, in some embodiments, the system can be configured to automatically determine a horizon line of the two-dimensional image, which can correspond to the boundary between quadrant 2 and quadrant 3 as illustrated in FIG. 4D, for example by utilizing edge detection. Also, in certain embodiments, the system can be configured to automatically identify one or more features in the two-dimensional input image to protect from distortion and such features can be ensured by the system to remain in either quadrant 2 or quadrant 3, as illustrated in FIG. 4D. Accordingly, in such embodiments, the system can be configured to identify a top line and a bottom line, wherein the top line defines a boundary between quadrants 1 and 2 and wherein the bottom line defines the boundary between quadrants 3 and 4, to ensure that all of the features identified as being necessary to be protected from distortion can be located within quadrants 2 and 3. In contrast, features appearing in quadrants 1 and 2 can be generic features, such as grass, dirt, the sky, or the like.

In certain embodiments, the system can allow a user to define the four quadrants as illustrated in FIG. 4D. For example, in some embodiments, the system can allow a user to define a horizon line as previously discussed, thereby defining a boundary between quadrants 2 and 3 as illustrated in FIG. 4D. Similarly, in some embodiments, the system can allow a user to identify one or more features that should be protected from distortion and allow a user to define the top line and the bottom line to ensure that such features of interest appear only in quadrants 2 and 3 as illustrated in FIG. 4D. In certain embodiments, after the quadrants are identified preliminarily, the system can allow a user to modify the horizon line, the top line, and/or the bottom line, to adjust the four quadrants as identified on the two-dimensional image at block 414.

In some embodiments, to properly correct the horizon, it can be advantageous to move and/or define the horizon line to the exact center of the two-dimensional input image or photograph. In other words, the input image can be modified such that the horizon line appears exactly along the middle pixels of the image. In order to do so, in certain embodiments, either quadrant 1 or quadrant 4 can be stretched vertically to extend the photograph or image without distorting quadrants 2 or 3. As such, it can be important to ensure that all of the features that need to be protected from distortion appear within quadrants 2 and 3 by defining and/or adjusting the top line and the bottom line accordingly. In certain embodiments, if the original horizon line is initially below the halfway mark of the image, quadrant 4 can be stretched. Conversely, if the original horizon line is initially above the halfway mark of the image, quadrant 1 can be stretched in order to correct the horizon. Stretching of either quadrant 1 or 4 can be applied to ensure that the new horizon line lies exactly at the halfway point vertically within the input image or photograph for conversion to virtual reality content.

### Spherinder Projection

In some embodiments, the system can be configured to project the two-dimensional input image that was selected for conversion to virtual reality content onto one or more projections, such as a three-dimensional projection. For example, in certain embodiments, the system can be configured to apply a spherical or half-spherical projection to quadrants 1 and 4 and/or apply a cylindrical projection to quadrants 2 and 3 in order to protect the features appearing in quadrants 2 and 3 from distortion. This combination of one or more spherical or half-spherical and/or one or more cylindrical projections can be denoted as a “spherinder” projection as used herein.

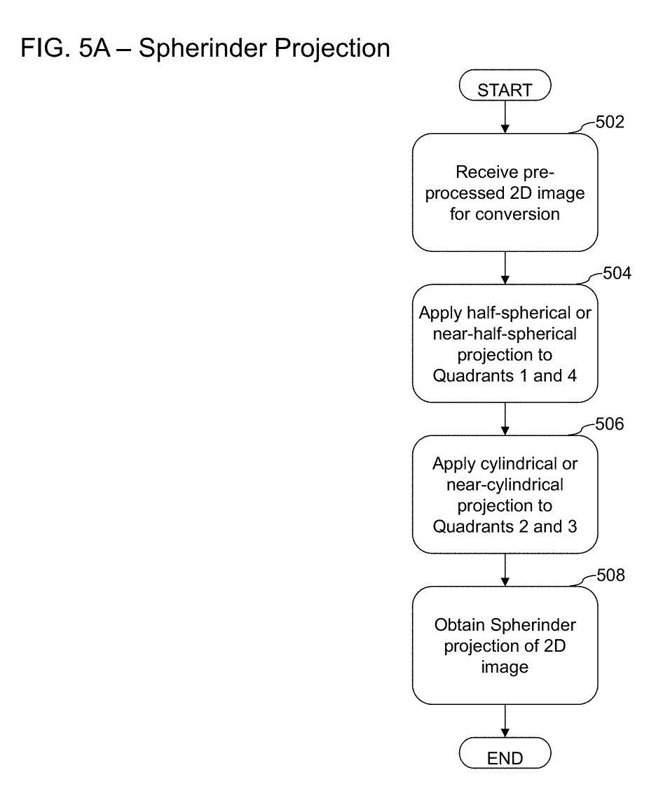

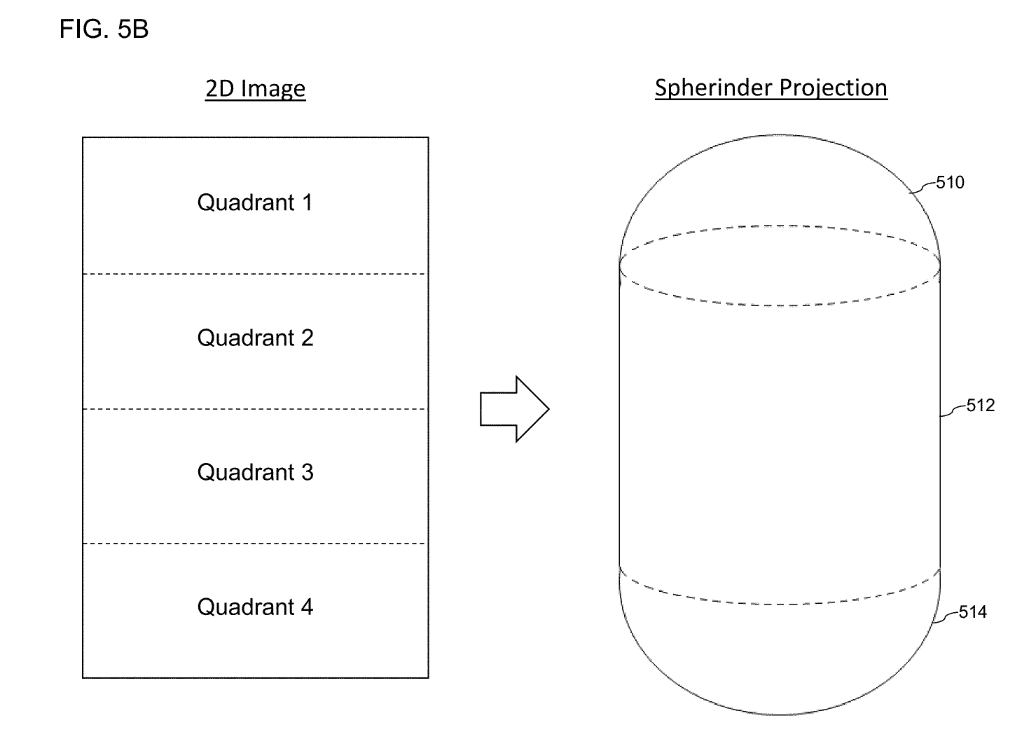

FIG. 5A is a flowchart depicting one or more embodiments of methods for applying a spherinder projection to a two-dimensional input image for generating virtual reality content. One or more processes for projecting an input planar image onto a spherinder projection can utilize an automated, semi-automated, and/or manual process. In some embodiments, the system can be configured to receive one or more two-dimensional images for conversion to virtual reality content at block 502. In certain embodiments, the system can be configured to apply a half spherical and/or near half spherical projection to quadrants 1 and/or 4 of the two-dimensional input image at block 504. The half-spherical projection of quadrants 1 and 4 can be opposite to each other in orientation and/or comprise opposite fractions of a full sphere as illustrated in FIG. 5B.

In some embodiments, to reduce pinching at the polls, the system can be configured to project the two-dimensional image to a sphere in quadrants 1 and 4 using a horizontal stretch. As previously discussed, this horizontal stretch can be applied only to quadrants 1 and 4 to keep quadrants 2 and 3 from being distorted. In certain embodiments, the system can be configured to apply a cylindrical and/or near cylindrical projection to quadrants 2 and 3 at block 506. As such, the portion of each row's pixel data can be taken from the center of the row and stretched to fit the full frame to fit the rectangular format in some embodiments. In some embodiments, the horizontal stretch for each row can use only a percentage of the total pixels for that row given by the following equations.

$$\begin{matrix}f ( row ) = sin ( \frac{row}{top} \frac{π}{2} ) & Quadrant 1 \\ f ( row ) = 1 & Quadrants 2 \& 3 \\ f ( row ) = cos ( \frac{row \text{-} bottom}{size \text{-} bottom} \frac{π}{2} ) & Quadrants 4\end{matrix}$$

As such, in certain embodiments, the resulting projection can mimic a cylinder in quadrants 2 and 3 with spherical caps in quadrants 1 and 4. The size and/or curvature of the spherical caps can be proportional to the vertical size of the quadrant it projects in some embodiments. After this step, in certain embodiments, the output can have distortions that resemble the distortions of the equirectangular format for half of a sphere. In certain embodiments, the spherinder projection process or technique can remove some of the pixel information from the corners of the image, in quadrants 1 and 4 for example, similar to cutting a circle out of a rectangular image. As a result, in certain embodiments, the system can be configured to obtain a spherinder projection of the two-dimensional image at block 508.

FIG. 5B illustrates an example of applying a spherinder projection to a two-dimensional input image for generating virtual reality content. As depicted in FIG. 5B, quadrants 2 and 3 can be projected to a cylinder 512. Also, as described above, quadrants 1 and 4 can be projected to half spheres 510, 514 with opposite directions in orientation. The resulting projection of the two-dimensional image can comprise a cylinder 512 in the middle corresponding to quadrants 2 and 3, thereby not distorting any of the features that appear in quadrants 2 and 3. In addition, quadrants 1 and 4 and features appearing therein can be distorted by projection onto a sphere or half-spheres 510, 514. Further, certain pixels in quadrants 1 and 4 can be removed through the projection process; however, this can be acceptable if quadrants 1 and 4 do not comprise any features of interest. As such, by combining the two opposite half-spherical projections and the cylindrical projection, the system can obtain a spherinder projection as illustrated in FIG. 5B.

### Pole-Protection

In some embodiments, however, because a spherinder projection is not equivalent to a complete spherical projection, its planar form may not be completely equirectangular. As a result, the cylindrical portion of the original input image that may correspond to quadrants 2 and 3 can exist toward the top and/or bottom of the resulting planar image. This can cause certain features in those areas to appear much taller than intended when taken to be equirectangular and/or when viewed on a virtual reality device or system.

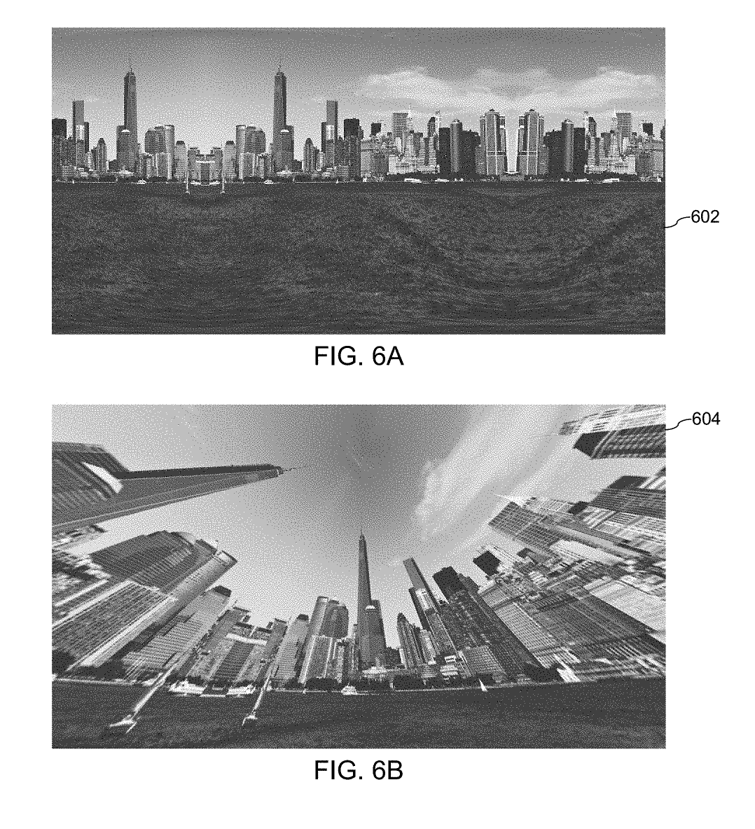

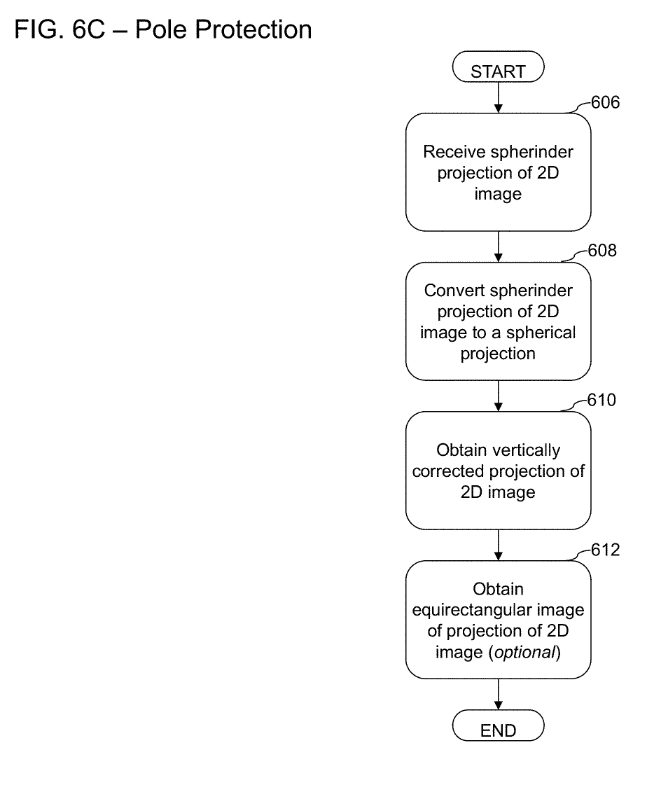

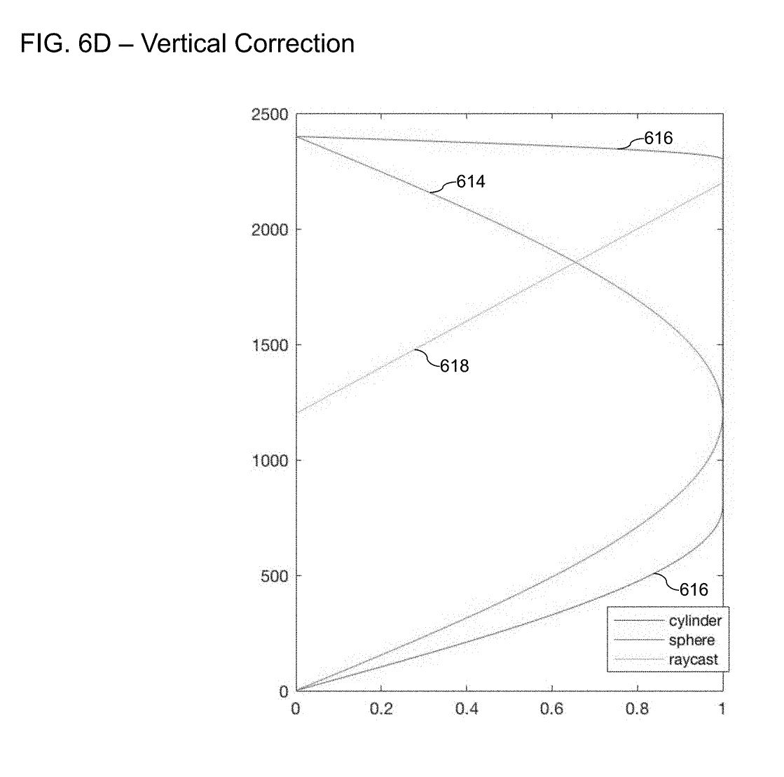

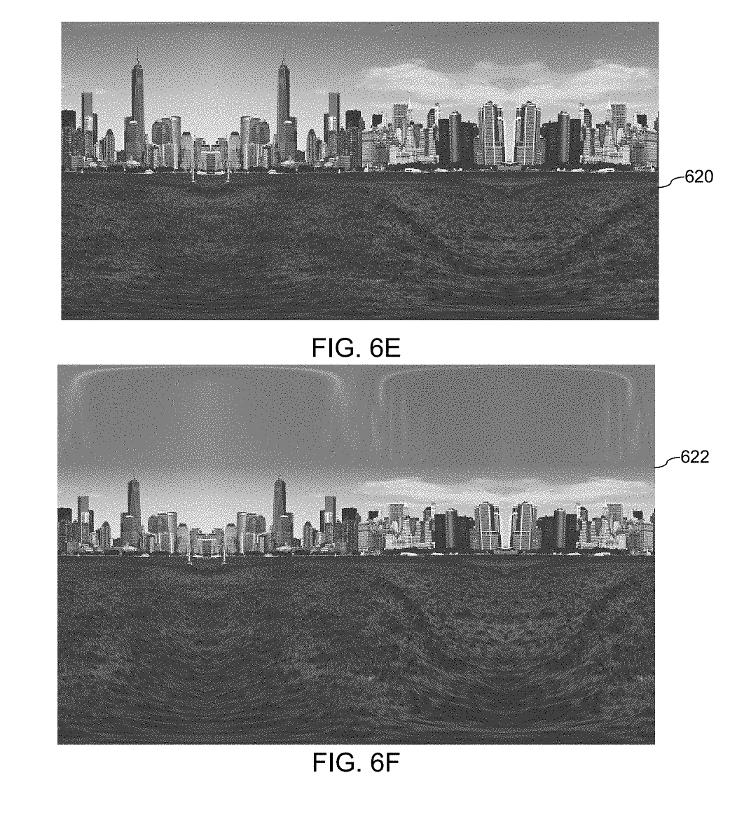

For example, FIG. 6A illustrates an example of planar projection of a spherinder projection of a two-dimensional input image without applying pole-protection and/or vertical correction. FIG. 6B illustrates the spherinder projection of FIG. 6A of the two-dimensional input image when viewed as virtual reality content. As illustrated in FIG. 6B, without applying any pull protection and/or vertical correction, some of the buildings in FIGS. 6A and/or 6B can appear substantially taller than intended when viewed as virtual reality content. As such, it can be advantageous to apply pole protection and/or vertical correction to a spherinder projection obtained from a two-dimensional input image.

FIG. 6C is a flowchart depicting one or more embodiments of methods for applying pole protection and/or vertical correction to a to a spherinder projection obtained from a two-dimensional input image for generating virtual reality content. One or more processes for pole protection and/or vertical correction can utilize an automated, semi-automated, and/or manual process. As illustrated in FIG. 6C, in some embodiments, the system can be configured to receive a spherinder projection obtained from a two-dimensional input image at block 606. In certain embodiments, the system can be configured to apply a spherical projection to the spherinder projection obtained from the two-dimensional image at block 608. By converting the spherinder projection to a sphere, the system can be configured to obtain a vertical correction of the projected two-dimensional image at block 610. Further, in certain embodiments, the system can be configured to obtain an equirectangular image of the spherical projection at block 612, which can be optional.

In other words, in order to correct for the vertical distortion, the system can be configured to project the spherinder projection to a sphere in some embodiments. Then, in certain embodiments, the system can be further configured to project the sphere back to an equirectangular projection if necessary. Because a spherinder, as defined herein, is rotationally symmetric about the vertical axis as a sphere, such correction can be purely a change in vertical coordinates.

For example, FIG. 6D illustrates an example of applying vertical correction and/or pole protection to a spherinder projection obtained from a two-dimensional input image for generating virtual reality content. As illustrated in FIG. 6D, line 614 can correspond to a spherical projection, line 616 can correspond to a spherinder projection of a two-dimensional image, and line 618 can correspond to a raycast.

More specifically, line 616 can show the radius of a spherinder at each pixel row for an image with a top at 600, bottom at 2200, and a size of 2400. Line 614 can correspond to the radius of a sphere. Line 618 can correspond to a raycast from the horizon at 1200 with an elevation angle of about 4 to 5 degrees for example. In some embodiments, the vertical correction, as applied to an image with coordinates corresponding to those illustrated in FIG. 6D, can map the vertical row coordinate or Y axis coordinate where the raycast 618 and spherinder line 616 intersect to the vertical row coordinate where the spherical line 614 and raycast 618 intersect. As such, in some embodiments, pole protection or vertical correction processes can utilize a bisection search, iterative process, and/or interpolation process to resample one or more pixels of a spherinder projection to a wholly spherical projection. More specifically, in certain embodiments, one or more pixels in quadrants 1 and 4 can be stretched out, while compacting one or more pixels in quadrants 2 and 3 to allow one or more features in the image to appear as their proper sizes. As such, this correction can force all objects in quadrants 2 and 3 to appear to be their correct size as intended and remove or at least decrease vertical distortion.

FIG. 6E depicts an example planar projection of a spherinder projection obtained from a two-dimensional input image without applying pole protection and/or vertical correction. In contrast, FIG. 6F illustrates the planar projection of FIG. 6E of the spherinder projection obtained from the two-dimensional input image after applying pole protection and/or vertical correction. As shown in FIG. 6F, the buildings can appear as their intended height, or relatively shorter when compared to FIG. 6E, after applying vertical correction and/or pole protection.

### Mirroring

In some embodiments, by applying one or more image processing and/or techniques described herein, the system can obtain an equirectangular image for a half sphere and/or with a viewing angle of about 180 degrees. In other words, when viewed using a virtual reality content viewing device, a user may only see a half-sphere view. This can be because the original input is a two-dimensional image and one or more processes or techniques described herein relate to modifying the two-dimensional image as provided. Accordingly, it can be advantageous to provide processing techniques for generating the other half of the sphere to provide a fully immersive 360 degree virtual reality viewing content.

In some embodiments, to generate the other half of the sphere, the system can be configured to simply mirror the image from the one-half sphere to the other one-half sphere across the middle plane to obtain a reflection of the equirectangular image. In certain embodiments, this can be done in equirectangular space simply by concatenating the resulting image with a horizontally flipped version of itself.

In certain embodiments, the system can be configured to apply smart mirroring, which can use a more intricate mirroring method that can flip the image multiple times about an axis in the image that is chosen or selected based on low energy vertical lines within the image. In other words, instead of simply mirroring a hemisphere itself, the system can be configured to mirror one or more portions of the image back and forth, each with certain degrees horizontally, to obtain a full sphere. For example, one or more portions of the image to be mirrored can comprise a horizontal angle of about 5 degrees, about 10 degrees, about 15 degrees, about 30 degrees, about 45 degrees, about 60 degrees, about 75 degrees, about 90 degrees, about 105 degrees, about 120 degrees, about 135 degrees, about 150 degrees, about 165 degrees, about 180 degrees, and/or within a range defined by two of the aforementioned values. In some embodiments, the system can be configured to automatically, semi-automatically, and/or manually determine one or more portions of the image that should be mirrored and/or should be protected from being mirrored. For example, the system can be configured to determined one or more unnoticeable portions or the image with low energy that can be mirrored to add pixels to obtain an unnoticeable result. As such, the smart mirroring method can produce better quality mirrors in certain cases, for example where there is horizontal homogeneity within the image. However, other embodiments may not employ such smart mirroring techniques or processes because the performance gain can be minimal and/or can be applicable only to a small percentage of cases or images with horizontal homogeneity.

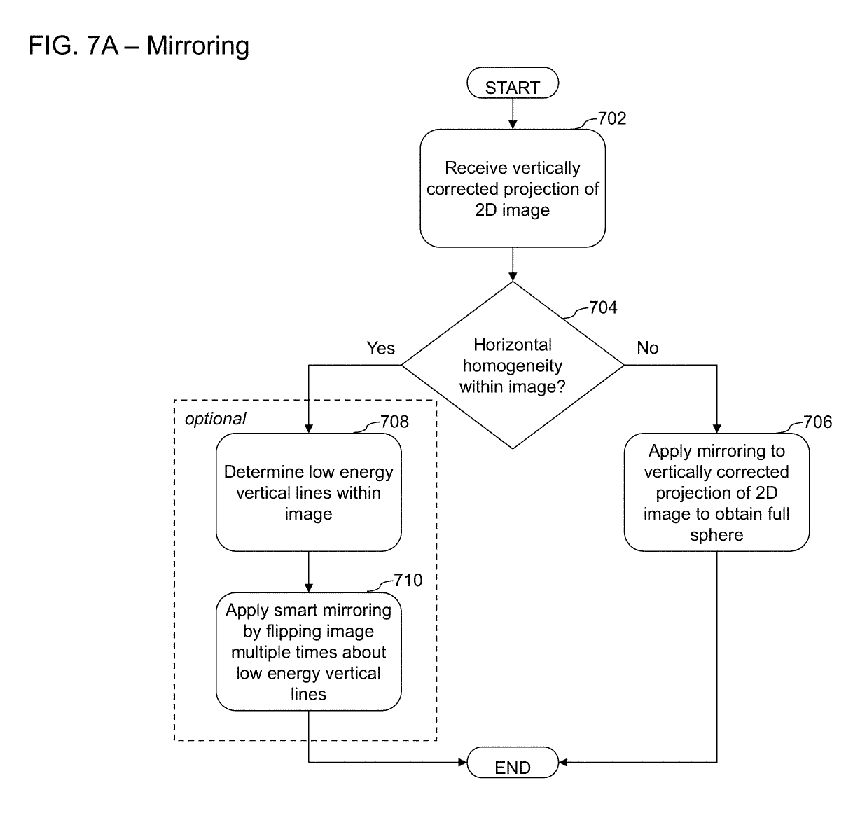

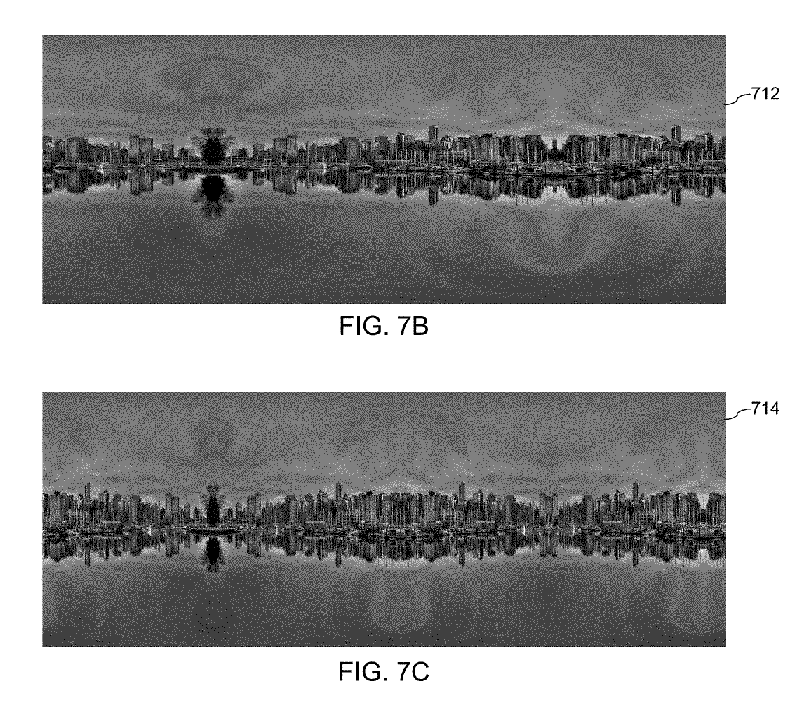

FIG. 7A is a flowchart illustrating one or more embodiments of methods for applying mirroring to a vertically corrected projection, such as a spherinder projection, obtained from a two-dimensional input image for generating virtual reality content. In some embodiments, the system can be configured to receive a vertically corrected projection of a two-dimensional image at block 702.

In certain embodiments, the system can be configured to determine whether the image comprises horizontal homogeneity at block 704 to determine whether to apply mirroring or smart mirroring techniques or processes. In order to do so, the system can be configured to identify and/or analyze one or more pixels along a horizontal line across the image. For example if the system determines that a gradient change in the color and/or shade of a plurality of pixels across a horizontal line within the image is above a predetermined threshold, the system can be configured to determine that horizontal homogeneity does not exist within the image. If so, the system can be configured to apply regular mirroring to the vertically corrected projection of the two-dimensional image to obtain a full sphere at block 706. In other words, the system can be configured to simply mirror the entire image across either the left and/or right edge of the image to obtain a full sphere.

Conversely, if the system determines that the image comprises horizontal homogeneity at block 704, the system can be configured to apply smart mirroring processes and/or techniques. For example, if the gradient change in color and/or shade of a plurality of pixels across a horizontal line of the image is below a predetermined threshold, the system can be configured to determine that a horizontal homogeneity exists within the image and apply smart mirroring processes and/or techniques.

In some embodiments, the system can be configured to determine or identify one or more low energy vertical lines with in the image at block 708. To do so, the system can be configured to analyze the gradient change in color and/or shade of a plurality of pixels across one or more vertical lines within the image. In certain embodiments, the system can further be configured to apply smart mirroring processes and/or techniques at block 710, for example by flipping the image one or multiple times around the one or more low energy vertical lines that were identified. Accordingly, the system can be configured to obtain a full sphere either by applying regular mirroring processing techniques and/or smart mirroring processing techniques.

FIG. 7B illustrates an example of planar projection of a vertically corrected projection such as a spherinder projection obtained from a two-dimensional input image after applying an embodiment of mirroring. As illustrated in FIG. 7B, by applying regular mirroring processes and/or techniques, the resulting planar projection comprise substantially a repeat of the initial planar projection to form a full sphere.

FIG. 7C illustrates an example of planar projection of a vertically corrected projection, such as a spherinder projection, obtained from a two-dimensional image after applying an embodiment of smart mirroring. As illustrated in FIG. 7C, by applying a smart mirroring process and/or technique, the resulting planar projection can comprise repeated views of a plurality of portions of the initial projection to form a full sphere.

### System for Generating Virtual Reality Content

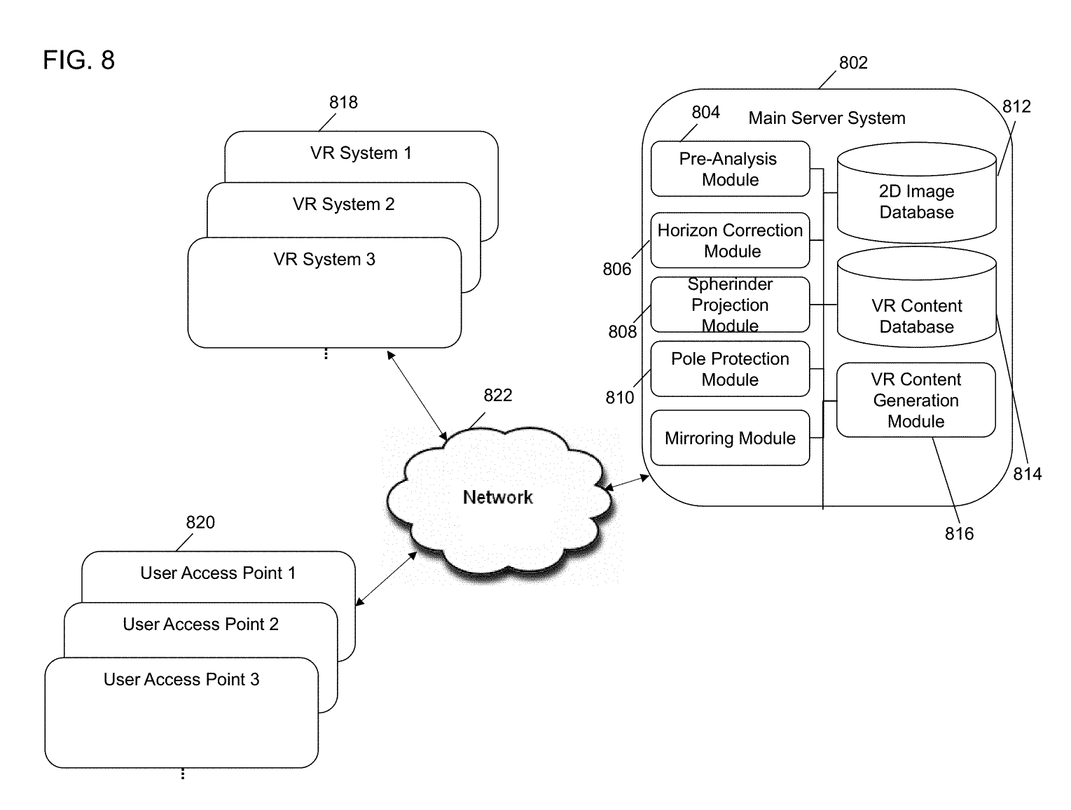

FIG. 8 is an embodiment of a schematic diagram illustrating a virtual reality content generation system. In some embodiments, a main server system 802 can comprise a pre-analysis module 804, a horizon correction module 806, a spherinder projection module 808, a pole protection module 810, a mirroring module 810, a virtual reality content generation module 816, a two-dimensional image database 812, and/or a virtual reality content database 814. The main server system can be connected to a network 822. The network can be configured to connect the main server to one or more user access point systems 820 and/or one or more virtual reality systems 818.

### Computer System

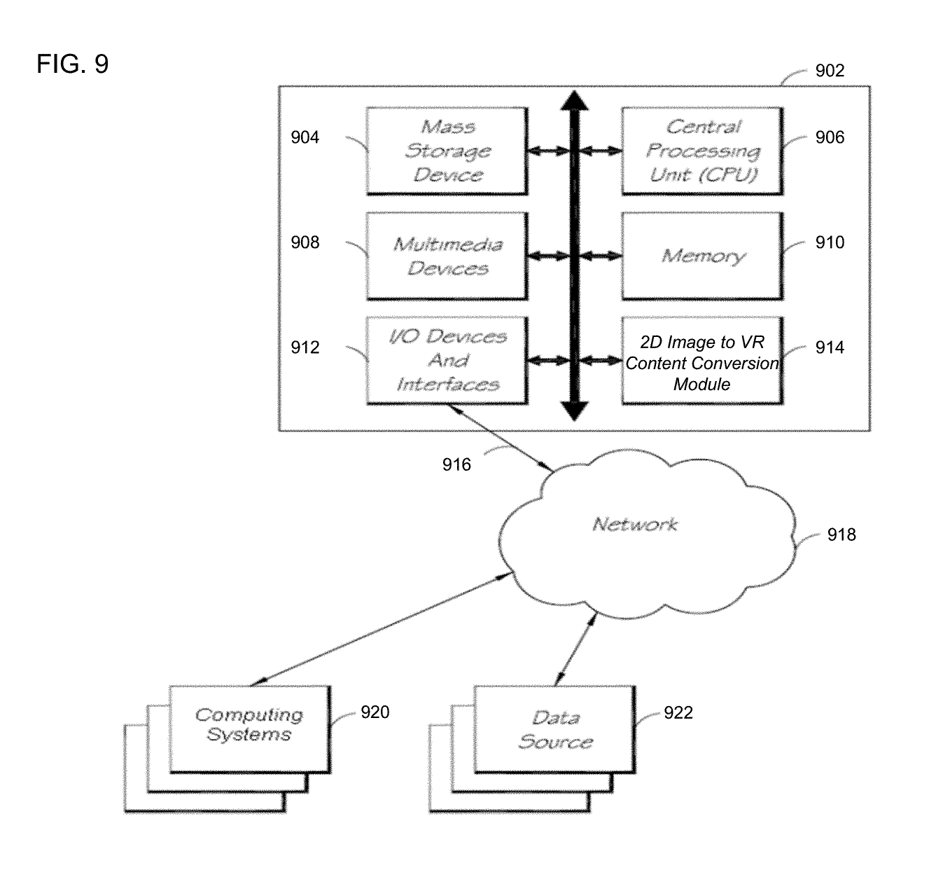

In some embodiments, the systems, processes, and methods described herein are implemented using a computing system, such as the one illustrated in FIG. 9. The example computer system 902 is in communication with one or more computing systems 920 and/or one or more data sources 922 via one or more networks 918. While FIG. 9 illustrates an embodiment of a computing system 902, it is recognized that the functionality provided for in the components and modules of computer system 902 can be combined into fewer components and modules, or further separated into additional components and modules.

The computer system 902 can comprise a two-dimensional image to virtual reality content conversion module 914 that carries out the functions, methods, acts, and/or processes described herein. The two-dimensional image to virtual reality content conversion module 914 is executed on the computer system 902 by a central processing unit 906 discussed further below.

In general the word “module,” as used herein, refers to logic embodied in hardware or firmware or to a collection of software instructions, having entry and exit points. Modules are written in a program language, such as JAVA, C, or C++, or the like. Software modules can be compiled or linked into an executable program, installed in a dynamic link library, or can be written in an interpreted language such as BASIC, PERL, LAU, PHP or Python and any such languages. Software modules can be called from other modules or from themselves, and/or can be invoked in response to detected events or interruptions. Modules implemented in hardware include connected logic units such as gates and flip-flops, and/or can include programmable units, such as programmable gate arrays or processors.

Generally, the modules described herein refer to logical modules that can be combined with other modules or divided into sub-modules despite their physical organization or storage. The modules are executed by one or more computing systems, and can be stored on or within any suitable computer readable medium, or implemented in-whole or in-part within special designed hardware or firmware. Not all calculations, analysis, and/or optimization require the use of computer systems, though any of the above-described methods, calculations, processes, or analyses can be facilitated through the use of computers. Further, in some embodiments, process blocks described herein can be altered, rearranged, combined, and/or omitted.

### Computing System Components

The computer system 902 includes one or more processing units (CPU) 906, which can comprise a microprocessor. The computer system 902 further includes a physical memory 910, such as random access memory (RAM) for temporary storage of information, a read only memory (ROM) for permanent storage of information, and a mass storage device 904, such as a backing store, hard drive, rotating magnetic disks, solid state disks (SSD), flash memory, phase-change memory (PCM), 3D XPoint memory, diskette, or optical media storage device. Alternatively, the mass storage device can be implemented in an array of servers. Typically, the components of the computer system 902 are connected to the computer using a standards based bus system. The bus system can be implemented using various protocols, such as Peripheral Component Interconnect (PCI), Micro Channel, SCSI, Industrial Standard Architecture (ISA) and Extended ISA (EISA) architectures.

The computer system 902 includes one or more input/output (I/O) devices and interfaces 912, such as a keyboard, mouse, touch pad, and printer. The I/O devices and interfaces 912 can include one or more display devices, such as a monitor, that allows the visual presentation of data to a user. More particularly, a display device provides for the presentation of GUIs as application software data, and multi-media presentations, for example. The I/O devices and interfaces 912 can also provide a communications interface to various external devices. The computer system 902 can comprise one or more multi-media devices 908, such as speakers, video cards, graphics accelerators, and microphones, for example.

### Computing System Device/Operating System

The computer system 902 can run on a variety of computing devices, such as a server, a Windows server, a Structure Query Language server, a Unix Server, a personal computer, a laptop computer, and so forth. In other embodiments, the computer system 902 can run on a cluster computer system, a mainframe computer system and/or other computing system suitable for controlling and/or communicating with large databases, performing high volume transaction processing, and generating reports from large databases. The computing system 902 is generally controlled and coordinated by an operating system software, such as z/OS, Windows, Linux, UNIX, BSD, PHP, SunOS, Solaris, MacOS, ICloud services or other compatible operating systems, including proprietary operating systems. Operating systems control and schedule computer processes for execution, perform memory management, provide file system, networking, and I/O services, and provide a user interface, such as a graphical user interface (GUI), among other things.

### Network

The computer system 902 illustrated in FIG. 9 is coupled to a network 918, such as a LAN, WAN, or the Internet via a communication link 916 (wired, wireless, or a combination thereof). Network 918 communicates with various computing devices and/or other electronic devices. Network 918 is communicating with one or more computing systems 920 and one or more data sources 922. The two-dimensional image to virtual reality content conversion module 914 can access or can be accessed by computing systems 920 and/or data sources 922 through a web-enabled user access point. Connections can be a direct physical connection, a virtual connection, and other connection type. The web-enabled user access point can comprise a browser module that uses text, graphics, audio, video, and other media to present data and to allow interaction with data via the network 918.

The output module can be implemented as a combination of an all-points addressable display such as a cathode ray tube (CRT), a liquid crystal display (LCD), a plasma display, a light emitting diode (LED) display, or other types and/or combinations of displays. The output module can be implemented to communicate with input devices 912 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module can communicate with a set of input and output devices to receive signals from the user.

### Other Systems

The computing system 902 can include one or more internal and/or external data sources (for example, data sources 922). In some embodiments, one or more of the data repositories and the data sources described above can be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 902 can also access one or more databases 922. The databases 922 can be stored in a database or data repository. The computer system 902 can access the one or more databases 922 through a network 918 or can directly access the database or data repository through I/O devices and interfaces 912. The data repository storing the one or more databases 922 can reside within the computer system 902.

### URLs and Cookies

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Doman Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

What is claimed is:

1. A computer-implemented method for processing a two-dimensional flat image to generate virtual reality content, the computer-implemented method comprising:
receiving, by a computer system, selection of a two-dimensional image for conversion to virtual reality content;
identifying, using the computer system, a top quadrant, an upper middle quadrant, a lower middle quadrant, and a bottom quadrant of the two-dimensional image, wherein the upper middle quadrant and the lower middle quadrant comprise one or more features to protect from distortion;
converting, by the computer system, the two-dimensional image to a part-spherical and part-cylindrical projection by:
applying a spherical projection to the top quadrant and the bottom quadrant; and
applying a cylindrical projection to the upper middle quadrant and the lower middle quadrant;
applying, by the computer system, a vertical correction of the part-spherical and part-cylindrical projection of the two-dimensional image by reproducing the part-spherical and part-cylindrical projection into a spherical projection;
converting, by the computer system, the spherically converted projection of the part-spherical and part-cylindrical projection of the two-dimensional image to a first equirectangular image, wherein the first equirectangular image comprises a first viewing angle of substantially 180 degrees;
mirroring, by the computer system, one or more portions of the first equirectangular image to obtain a second equirectangular image, wherein the second equirectangular image comprises a width substantially twice as wide as a width of the first equirectangular image, and wherein the second equirectangular image comprises a second viewing angle of substantially 360 degrees; and
storing the second equirectangular image on a server for displaying on a virtual reality viewing device as virtual reality content,
wherein the computer system comprises a computer processor and an electronic storage medium.

2. The computer-implemented method of claim 1, further comprising determining, by the computer system, a likelihood of success of converting the two-dimensional image to virtual reality content.

3. The computer-implemented method of claim 2, wherein determining the likelihood of success of converting the two-dimensional image to virtual reality content is based at least in part on one or more of a view direction of the two-dimensional image, presence of homogeneous textures in the top quadrant of the two-dimensional image, presence of homogenous textures in the bottom quadrant of the two-dimensional image, field of view of the two-dimensional image, or presence of orthogonal structures in the top quadrant of the two-dimensional image.

4. The computer-implemented method of claim 1, further comprising, identifying, by the computer system, one or more portions of the two-dimensional image with a likelihood of success of conversion to virtual reality content above a predetermined threshold.

5. The computer-implemented method of claim 1, wherein the determining the top quadrant, the upper middle quadrant, the lower middle quadrant, and the bottom quadrant of the two-dimensional image is performed automatically by the computer system.

6. The computer-implemented method of claim 1, wherein the determining the top quadrant, the upper middle quadrant, the lower middle quadrant, and the bottom quadrant of the two-dimensional image is performed by a user utilizing a computerized tool on the computer system.

7. The computer-implemented method of claim 1, wherein a boundary of the upper middle quadrant and the lower middle quadrant corresponds to a horizon line of the two-dimensional image.

8. The computer-implemented method of claim 7, further comprising adjusting vertical heights of the top quadrant and the bottom quadrant to position the horizon line at a center of the two-dimensional image.

9. The computer-implemented method of claim 1, wherein applying the spherical projection to the top quadrant and the bottom quadrant comprises stretching at least a portion of the top quadrant and the bottom quadrant.

10. The computer-implemented method of claim 1, wherein reproduction of the part-spherical and part-cylindrical projection into the spherical projection decreases inner-quadrant vertical distortion.

11. The computer-implemented method of claim 1, wherein the mirroring comprises identifying one or more vertical lines of low energy and flipping a portion of the first equirectangular projection across the one or more vertical lines.

12. The computer-implemented method of claim 1, further comprising generating and transmitting a URL directed to an electronic storage location on the server of the second equirectangular image to the virtual reality device, wherein activation of the URL by the virtual reality device initiates display of the second equirectangular image as virtual reality content.

13. A system for processing a two-dimensional flat image to generate virtual reality content, the system comprising:
one or more computer readable storage devices configured to store a plurality of computer executable instructions; and
one or more hardware computer processors in communication with the one or more computer readable storage devices and configured to execute the plurality of computer executable instructions in order to cause the system to:
receive selection of a two-dimensional image for conversion to virtual reality content;
receive identification of a top quadrant, an upper middle quadrant, a lower middle quadrant, and a bottom quadrant of the two-dimensional image, wherein the upper middle quadrant and the lower middle quadrant comprise one or more features to protect from distortion;
convert the two-dimensional image to a part-spherical and part-cylindrical projection by:
applying a spherical projection to the top quadrant and the bottom quadrant; and
applying a cylindrical projection to the upper middle quadrant and the lower middle quadrant;
apply a vertical correction of the part-spherical and part-cylindrical projection of the two-dimensional image by reproducing the part-spherical and part-cylindrical projection into a spherical projection;
convert the spherically converted projection of the part-spherical and part-cylindrical projection of the two-dimensional image to a first equirectangular image, wherein the first equirectangular image comprises a first viewing angle of substantially 180 degrees;
mirror one or more portions of the first equirectangular image to obtain a second equirectangular image, wherein the second equirectangular image comprises a width substantially twice as wide as a width of the first equirectangular image, and wherein the second equirectangular image comprises a second viewing angle of substantially 360 degrees; and
store the second equirectangular image on a server for displaying on a virtual reality viewing device as virtual reality content.

14. The system of claim 13, wherein the system is further caused to generate and transmit a URL directed to an electronic storage location of the second equirectangular image on the server to the virtual reality device, wherein activation of the URL by the virtual reality device initiates display of the second equirectangular image as virtual reality content.

15. The system of claim 13, wherein the system is further caused to determine a likelihood of success of converting the two-dimensional image to virtual reality content.

16. The system of claim 15, wherein determining the likelihood of success of converting the two-dimensional image to virtual reality content is based at least in part on one or more of a view direction of the two-dimensional image, presence of homogeneous textures in the top quadrant of the two-dimensional image, presence of homogenous textures in the bottom quadrant of the two-dimensional image, field of view of the two-dimensional image, or presence of orthogonal structures in the top quadrant of the two-dimensional image.

17. The system of claim 13, wherein the system is further caused to adjust vertical heights of the top quadrant and the bottom quadrant to position a boundary between the upper middle quadrant and the lower middle quadrant at a center of the two-dimensional image.

18. The system of claim 13, wherein applying the spherical projection to the top quadrant and the bottom quadrant comprises stretching at least a portion of the top quadrant and the bottom quadrant.

19. The system of claim 13, wherein reproduction of the part-spherical and part-cylindrical projection into the spherical projection decreases inner-quadrant vertical distortion.

20. The system of claim 13, wherein the mirroring comprises identifying one or more vertical lines of low energy and flipping a portion of the first equirectangular projection across the one or more vertical lines.
